(19) United States
(12) Patent Application Publication
(10) Pub. No.: US 2014/0257779 A1
(43) Pub. Date: Sep. 11, 2014

(54) METHOD AND APPARATUS FOR TRACING RAY PATH BY USING THREE-DIMENSIONAL MODELING STRUCTURE

(71) Applicant: ELECTRONICS AND TELECOMMUNICATIONS RESEARCH INSTITUTE, Daejeon (KR)

(72) Inventors: YOUNG KEUN YOON, Daejeon (KR); Jong Ho KIM, Daejeon (KR); Young Jun CHONG, Daejeon (KR); Jea Ick CHOI, Daejeon (KR)

(21) Appl. No.: 13/908,054

(22) Filed: Jun. 3, 2013

(30) Foreign Application Priority Data
Mar. 6, 2013 (KR) 10-2013-0023907

(51) Int. Cl. G06F 17/50

(52) U.S. Cl. CPC G06F 17/5009
USPC 703/6

(57) ABSTRACT

A ray path tracing method using a three-dimensional (3D) modeling structure, includes: generating and developing a 3D modeling structure of a glass window and a window frame; setting a ray transmitting point and a ray receiving point at respective positions, and generating a ray from the transmitting point; and forming a path of a transmitted wave ray, passing through the glass window and analyzing a propagation characteristic of the transmitted wave ray.

Further, the ray path tracing method includes forming respective paths of the transmitted wave ray, a reflected wave ray, and a diffracted wave ray, and analyzing respective propagation characteristics of the transmitted wave ray, reflected wave ray, and diffracted wave ray; and calculating electric field intensities at the receiving point about all the paths formed between the transmitting point and the receiving point.

### CROSS-REFERENCE TO RELATED APPLICATION(S)

The present invention claims priority of Korean Patent Application No. 10-2013-0023907, filed on Mar. 6, 2013, which is incorporated herein by reference.

### FIELD OF THE INVENTION

The present invention relates to a technique of tracing a ray path, and more particularly, to a ray path tracing method and apparatus suitable for tracing a ray path by using a three-dimensional (3D) modeling structure in a 3D ray tracing simulation for predicting a propagation characteristic of an indoor-outdoor communication environment.

### BACKGROUND OF THE INVENTION

A conventional 3D ray tracing technology uses a simple modeling method for analyzing a structure in a 3D ray tracing simulation.

FIG. 1 is a flowchart illustrating a main operation that traces a ray path for a 3D ray tracing prediction simulation in a conventional method.

Referring to FIG. 1, in executing a prediction simulation for tracing a 3D ray, the conventional method first generates and develops a 3D modeling structure for a glass window in operation 102, and then, for example, as illustrated in FIG. 2, sets a ray transmitting point and a ray receiving point at respective positions for predicting in the developed 3D modeling structure in operation 104.

Subsequently, when a ray is emitted from the transmitting point in operation 106, the conventional method forms a path of a transmitted wave ray, passing through the glass window, between the transmitting point and the receiving point, and then analyzes a propagation characteristic of the transmitted wave ray in operation 108. The conventional method calculates an electric field intensity (received power for a transmitted wave of the glass window) at the receiving point for the ray path formed between the transmitting point and the receiving point, based on the analyzed result of the propagation characteristic of the transmitted wave ray in operation 110.

### SUMMARY OF THE INVENTION

However, as it is required to analyze a propagation characteristic under a progressively complicated propagation environment and a high frequency, the above-described conventional method which considers only a propagation characteristic of a transmitted wave passing through a glass window inevitably has a limitation in increasing a degree of precision of a prediction result.

In view of the above, the present invention provides a new modeling technique and an analysis method thereof because an accurate modeling and analysis method for a structure for increasing a degree of precision of a prediction result is important, considering various propagation environments.

In accordance with a first aspect of the present invention, there is provided a ray path tracing method using a three-dimensional (3D) modeling structure, including: generating and developing a 3D modeling structure of a glass window and a window frame; setting a ray transmitting point and a ray receiving point at respective positions for predicting in the developed 3D modeling structure, and generating a ray from the transmitting point; forming a path of a transmitted wave ray, passing through the glass window, between the transmitting point and the receiving point, and analyzing a propagation characteristic of the transmitted wave ray; forming respective paths of the transmitted wave ray, a reflected wave ray, and a diffracted wave ray, which pass through the window frame, between the transmitting point and the receiving point, and analyzing respective propagation characteristics of the transmitted wave ray, reflected wave ray, and diffracted wave ray; and calculating electric field intensities at the receiving point about all the paths formed between the transmitting point and the receiving point, on the basis of the analyzed results of the respective propagation characteristics.

Further, the analyzing respective propagation characteristics may comprise checking whether a thickness of the window frame is relatively greater than a predetermined reference value compared to a wavelength of the ray; selecting a first edge at which the ray transferred from the transmitting point intersects the window frame, when the thickness of the window frame is not greater than the predetermined reference value; analyzing the propagation characteristic of the diffracted wave ray intersecting the first edge; selecting a plane and a second edge at which the rays transferred from the transmitting point intersect the window frame, when the thickness of the window frame is greater than the predetermined reference value; and analyzing the propagation characteristics of the reflected wave ray and transmitted wave ray intersecting the plane, and analyzing the propagation characteristic of the diffracted wave ray intersecting the second edge.

Further, the ray path tracing method may further comprise checking, after the analyzing of the propagation characteristics, whether there are a next intersection plane and a next intersection edge; and repeating the analyzing of the propagation characteristics when there are the next intersection plane and the next intersection edge.

Further, the electric field intensities may be received powers of all the rays or received power of the diffracted wave ray.

In accordance with a second aspect of the present invention, there is provided a ray path tracing apparatus using a three-dimensional (3D) modeling structure, including: a 3D modeling generating unit configured to generate and develop a 3D modeling structure of a glass window and a window frame; a ray path setting unit configured to set a ray transmitting point and a ray receiving point at respective positions for predicting in the developed 3D modeling structure; a ray generating unit configured to generate a ray used to analyze a propagation characteristic; a first propagation characteristic analyzing unit configured to analyze a propagation characteristic of a transmitted wave ray passing through the glass window disposed between the transmitting point and the receiving point; a second propagation characteristic analyzing unit configured to analyze respective propagation characteristics of the transmitted wave ray, a reflected wave ray, and a diffracted wave ray which pass through the window frame disposed between the transmitting point and the receiving point; and an electric field intensity calculating unit configured to calculate electric field intensities at the receiving point about all paths formed between the transmitting point and the receiving point, on the basis of the analyzed results from the first and propagation characteristic analyzing units.

Further, the second propagation characteristic analyzing unit may comprise a thickness comparator configured to compare a thickness of the window frame and a wavelength of the ray to check whether the thickness of the window frame is relatively greater than a predetermined reference value compared to the wavelength of the ray; a first point selector configured to select a first edge at which the ray transferred from the transmitting point intersects the window frame, when the thickness of the window frame is not greater than the predetermined reference value; a 2-1st propagation characteristic analyzer configured to analyze the propagation characteristic of the diffracted wave ray intersecting the first edge; a second point selector configured to select a plane and a second edge at which the rays transferred from the transmitting point intersect the window frame, when the thickness of the window frame is greater than the predetermined reference value; and a 2-2nd propagation characteristic analyzer configured to analyze the propagation characteristics of the reflected wave ray and transmitted wave ray intersecting the plane, and analyzing the propagation characteristic of the diffracted wave ray intersecting the second edge.

The ray path tracing apparatus may further comprise an intersection point monitor configured to analyze the propagation characteristics of the respective rays intersecting the plane and the second edge, check whether there are a next intersection plane and a next intersection edge, and, when there are the next intersection plane and the next intersection edge, command the 2-2nd propagation characteristic analyzer to analyze the propagation characteristics.

Further, the electric field intensities may be received powers of all the rays or received power of the diffracted wave ray.

### BRIEF DESCRIPTION OF THE DRAWINGS

The above and other objects and features of the present invention will become apparent from the following description of embodiments given in conjunction with the accompanying drawings, in which:

FIG. 1 is a flowchart illustrating a main operation that traces a ray path for a 3D ray tracing prediction simulation in a conventional method;

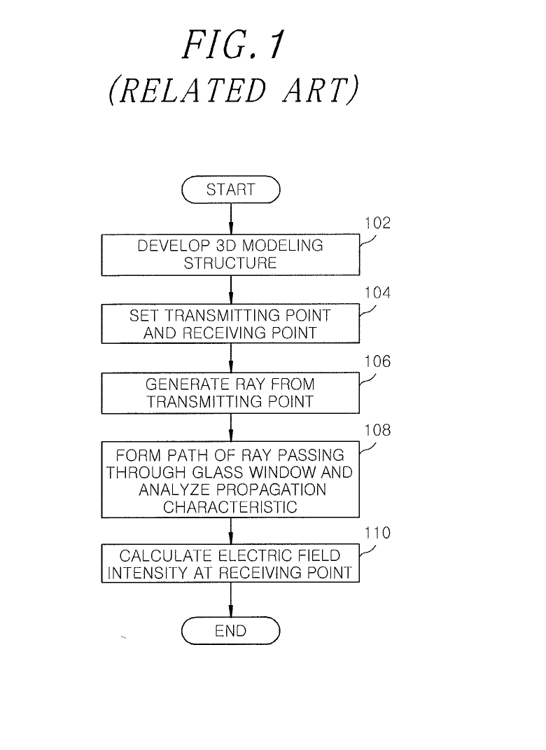

FIG. 2 is a block diagram illustrating a 3D modeling structure applied for tracing a ray path in the conventional method;

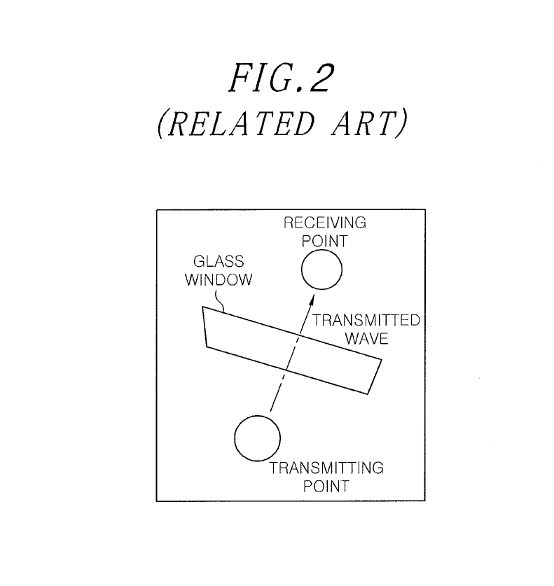

FIG. 3 is a block diagram illustrating a ray path tracing apparatus using a 3D modeling structure in accordance with an embodiment of the present invention;

FIG. 4A is an exemplary diagram showing a glass window and a window frame to be modeled in accordance with the present invention;

FIG. 4B is a diagram showing a 3D modeling structure applied for tracing a ray path in accordance with the present invention;

FIG. 5 is a detailed block diagram illustrating a second propagation analyzing unit of FIG. 3;

FIG. 6 is a flowchart illustrating a main operation that traces a ray path for a 3D ray tracing prediction simulation in accordance with the present invention; and

FIG. 7 is a flowchart illustrating a main operation that analyzes a propagation characteristic of a ray passing through a window frame in accordance with the present invention.

### DETAILED DESCRIPTION OF THE EMBODIMENTS

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims.

In the following description, when the detailed description of the relevant known function or configuration is determined to unnecessarily obscure the important point of the present invention, the detailed description will be omitted. Further, terms used herein are terms that have been defined in consideration of functions in embodiments, and the terms that have been defined as described above may be altered according to the intent of a user or operator, or conventional practice, and thus, the terms need to be defined on the basis of the entire content of this specification.

Hereinafter, embodiments of the present invention will be described in detail with reference to the accompanying drawings.

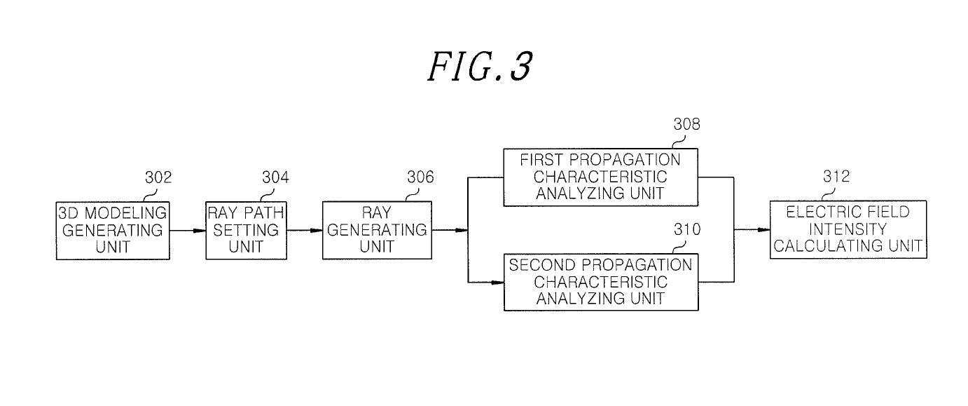

FIG. 3 is a block diagram illustrating a ray path tracing apparatus using a 3D modeling structure in accordance with an embodiment of the present invention.

Referring to FIG. 3, the ray path tracing apparatus of the present invention includes a 3D modeling generating unit 302, a ray path setting unit 304, a ray generating unit 306, a first propagation characteristic analyzing unit 308, a second propagation characteristic analyzing unit 310, and an electric field intensity calculating unit 312.

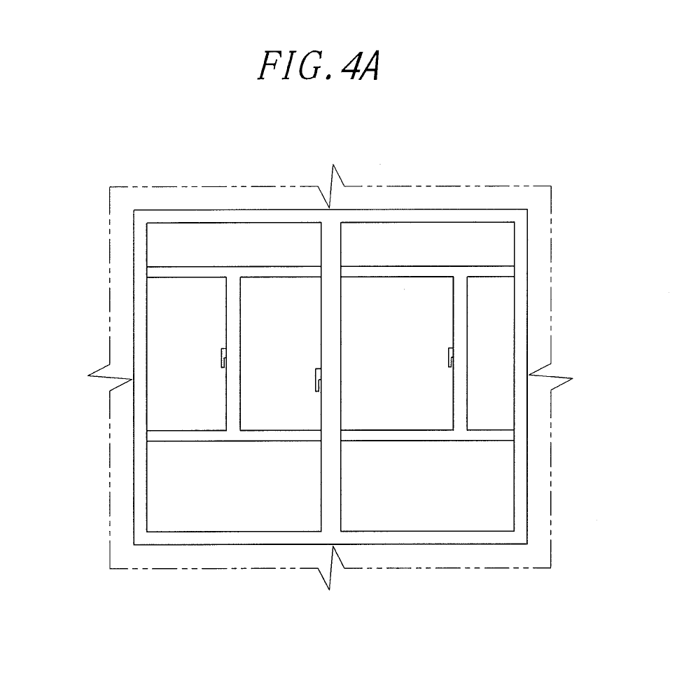

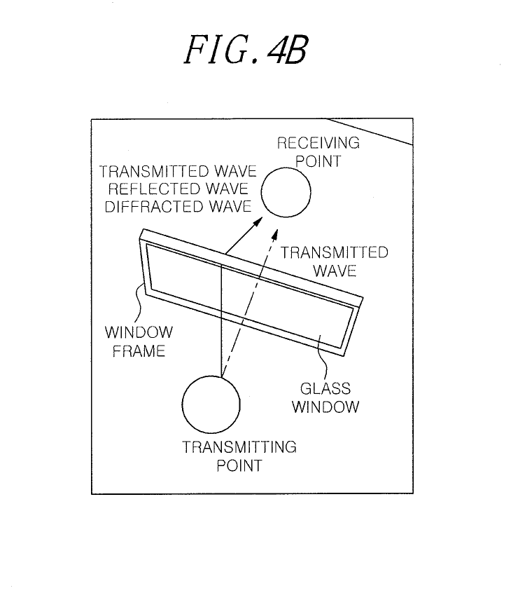

When a prediction simulation for tracing a 3D ray is executed, the 3D modeling generating unit 302 may generate and develop (develop a structure) a 3D modeling structure of a glass window and a window frame. For example, when a glass window and a window frame to be modeled in accordance with the present invention are assumed as shown in FIG. 4A, the 3D modeling generating unit 302 may generate, for example, a 3D modeling structure shown in FIG. 4B.

The ray path setting unit 304, for example, as shown in FIG. 4B, may set (fix a position) a ray transmitting point and a ray receiving point at respective positions for predicting in the developed 3D modeling structure of the glass window and window frame.

When the transmitting point and the receiving point are fixed (set) in position with the glass window and window frame therebetween, the ray generating unit 306 may generate a ray for analyzing a propagation characteristic. Here, the generated ray has a transmitted wave (transmitted wave ray) passing through the glass window in a direction from the transmitting point to the receiving point, and a transmitted wave, reflected wave, or diffracted wave which is reflected from the window frame.

The first propagation characteristic analyzing unit 308 may analyze a propagation characteristic of the transmitted wave ray (generated from the ray generating unit 306) passing through the glass window disposed between the transmitting point and the receiving point, and transfer the analyzed propagation characteristic to the electric field intensity calculating unit 312.

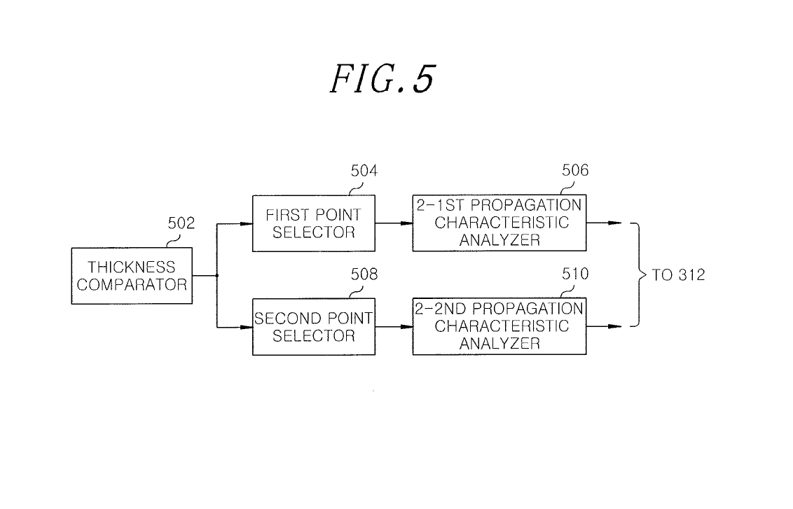

The second propagation characteristic analyzing unit 310 may analyze the propagation characteristics of the transmitted wave ray, reflected wave ray, and diffracted wave ray (which are generated from the ray generating unit 306) which pass through the window frame disposed between the transmitting point and the receiving point. To this end, the second propagation characteristic analyzing unit 310 may have a configuration of FIG. 5.

FIG. 5 is a detailed block diagram illustrating the second propagation analyzing unit of FIG. 3.

Referring to FIG. 5, the second propagation analyzing unit 310 may include a thickness comparator 502, a first point selector 504, a 2-1st propagation characteristic analyzer 506, a second point selector 508, and a 2-2nd propagation characteristic analyzer 510.

The thickness comparator 502 may compare a thickness (size) of the window frame and a wavelength of a ray to check whether the thickness of the window frame is relatively greater than a predetermined reference value compared to the wavelength of the ray. When the thickness of the window frame is not relatively greater than the predetermined reference value compared to the wavelength of the ray, the thickness comparator 502 may generate a first point selection signal corresponding to the compared result, and transfer the first point selection signal to the first point selector 504. When the thickness of the window frame is relatively greater than the predetermined reference value compared to the wavelength of the ray, the thickness comparator 502 may generate a second point selection signal corresponding to the compared result, and transfer the second point selection signal to the first point selector 504. Here, the predetermined reference value may denote that the thickness “t” of the window frame is approximate five or more times the wavelength (λ=light speed/frequency) of the ray.

Subsequently, when the first point selection signal is transferred from the thickness comparator 502, namely, when the thickness of the window frame is not relatively greater than the predetermined reference value compared to the wavelength of the ray, the first point selector 504 may select a point (edge) at which the ray transferred from the transmitting point intersects the window frame. The 2-1st propagation characteristic analyzer 506 may analyze the propagation characteristic of the diffracted wave ray which intersects the point (edge) selected by the first point selector 504, and transfer the analyzed propagation characteristic to the electric field intensity calculating unit 312 of FIG. 3.

Moreover, when the second point selection signal is transferred from the thickness comparator 502, namely, when the thickness of the window frame is relatively greater than the predetermined reference value compared to the wavelength of the ray, the second point selector 508 may select points (plane and edge) at which the rays transferred from the transmitting point intersect the window frame.

The 2-2nd propagation characteristic analyzer 510 may analyze the propagation characteristic of the reflected wave ray which intersects the plane selected by the second point selector 508 and the propagation characteristic of the transmitted wave ray which intersects the edge selected by the second point selector 508, and transfer the analyzed propagation characteristics to the electric field intensity calculating unit 312 of FIG. 3.

In this case, although not shown in FIG. 5, the 2-2nd propagation characteristic analyzer 510 may further include an intersection point monitor that analyzes the propagation characteristics of the respective rays intersecting the plane and the edge, checks whether there are a next intersection plane and a next intersection edge, and, when there are the next intersection plane and the next intersection edge, issues a command to successively analyze the propagation characteristics of the reflected wave ray, transmitted wave ray, and diffracted wave ray intersecting the next intersection plane and the next intersection edge.

Referring again to FIG. 3, the electric field intensity calculating unit 312 may calculate electric field intensities at the receiving point about all paths formed between the transmitting point and the receiving point, on the basis of the analyzed results of the propagation characteristics (i.e., the propagation characteristic of the transmitted wave ray, the propagation characteristic of the reflected wave ray, and the propagation characteristic of the diffracted wave ray) transferred from each of the first and second propagation characteristic analyzing units 308 and 310. Here, for example, the calculated electric field intensities may be received powers of all the rays or received power of the diffracted wave ray.

Next, a detailed description will be made on a series of operations in which the ray path tracing apparatus of the present invention having the above-described configuration traces a ray path for the 3D ray tracing prediction simulation.

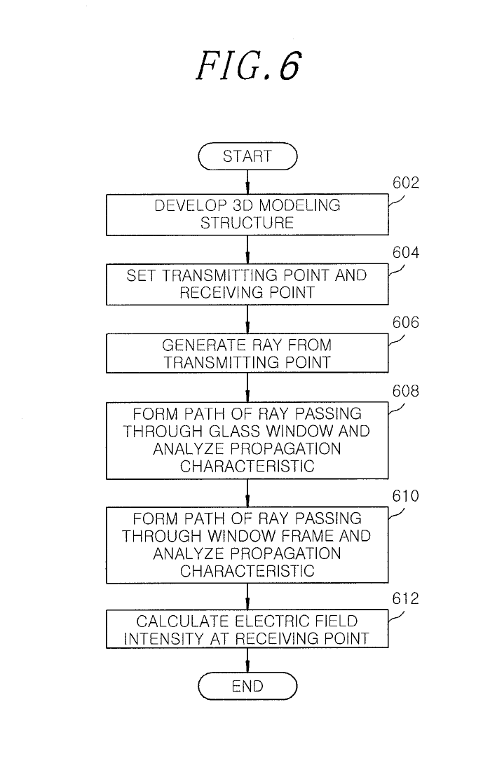

FIG. 6 is a flowchart illustrating a main operation that traces a ray path for the 3D ray tracing prediction simulation in accordance with the present invention.

Referring to FIG. 6, a prediction simulation for tracing a 3D ray is executed, for example, as shown in FIG. 4B, the 3D modeling generating unit 302 generates and develops (develop a structure) the 3D modeling structure of the glass window and the window frame in operation 602.

Subsequently, for example, as shown in FIG. 4B, the ray path setting unit 304 sets (fix a position) the ray transmitting point and the ray receiving point at respective positions for predicting in the developed 3D modeling structure of the glass window and window frame in operation 604. The ray generating unit 306 generates a ray for analyzing a propagation characteristic in operation 606. Here, the generated ray has a transmitted wave (transmitted wave ray) passing through the glass window in a direction from the transmitting point to the receiving point, and a transmitted wave, reflected wave, or diffracted wave which is reflected from the window frame.

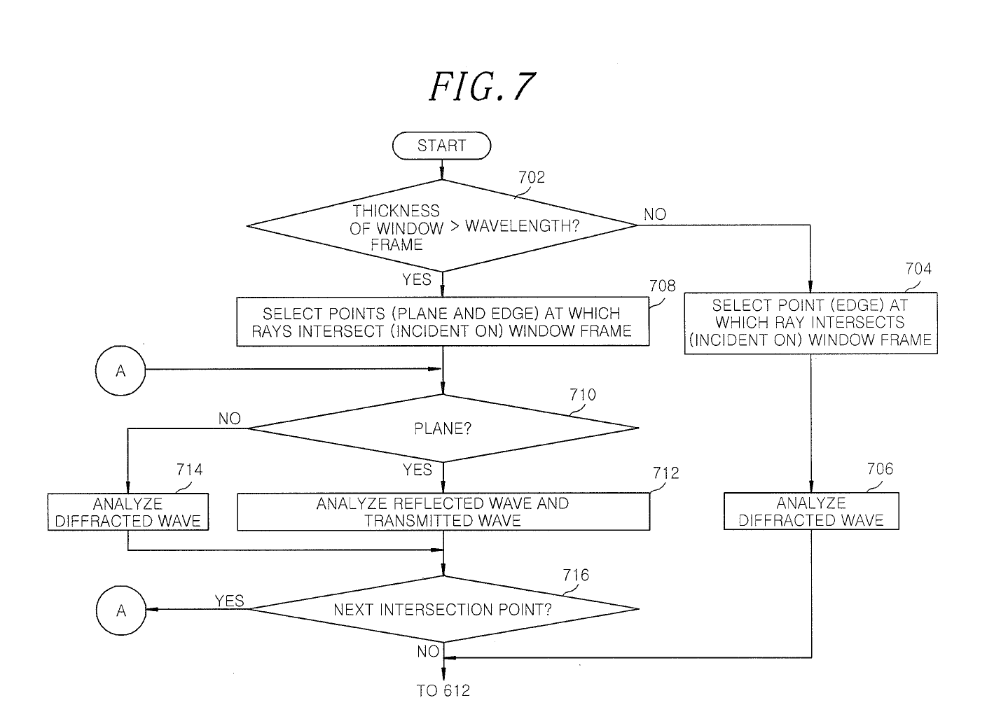

In response to this, the first propagation characteristic analyzing unit 308 analyzes a propagation characteristic of the transmitted wave ray passing through the glass window disposed between the transmitting point and the receiving point in operation 608, and the second propagation characteristic analyzing unit 310 analyzes the propagation characteristics of the transmitted wave ray, reflected wave ray, and diffracted wave ray which pass through the window frame disposed between the transmitting point and the receiving point in operation 610. An operation, which precisely analyzes the propagation characteristics of the rays passing through the window frame, will be described in more detail with reference to FIG. 7.

FIG. 7 is a flowchart illustrating a main operation that analyzes the propagation characteristic of the ray passing through the window frame in accordance with the present invention.

Referring to FIG. 7, the thickness comparator 502 compares a thickness (size) of the window frame and a wavelength of a ray to check whether the thickness of the window frame is relatively greater than a predetermined reference value compared to the wavelength of the ray in operation 702. When the thickness of the window frame is not relatively greater than the predetermined reference value compared to the wavelength of the ray as the checked result, the thickness comparator 502 generates the first point selection signal corresponding to the compared result.

In response to this, when the thickness of the window frame is not relatively greater than the predetermined reference value compared to the wavelength of the ray, the first point selector 504 selects a point (edge) at which the ray transferred from the transmitting point intersects the window frame in operation 704, and thus, the 2-1st propagation characteristic analyzer 506 analyzes the propagation characteristic of the diffracted wave ray which intersects the selected point (edge) in operation 706. At this time, the analyzed result (analyzed result of the propagation characteristic of the diffracted wave ray) is transferred to the electric field intensity calculating unit 312 of FIG. 3.

When it is checked in operation 702 that the thickness of the window frame is relatively greater than the predetermined reference value compared to the wavelength of the ray, the thickness comparator 502 generates the second point selection signal corresponding to the compared result.

In response to this, when the thickness of the window frame is relatively greater than the predetermined reference value compared to the wavelength of the ray, the second point selector 508 may select points (plane and edge) at which the rays transferred from the transmitting point intersect the window frame in operation 708. The 2-2nd propagation characteristic analyzer 510 checks whether a point intersecting the window frame is a plane in operation 710, and, when the point intersecting the window frame is determined as the plane, the 2-2nd propagation characteristic analyzer 510 analyzes the propagation characteristics of the reflected wave ray and transmitted wave ray intersecting the plane in operation 712. However, when the point intersecting the window frame is determined as an edge, the 2-2nd propagation characteristic analyzer 510 analyzes the propagation characteristic of the diffracted wave ray intersecting the edge in operation 714. At this time, the analyzed results (analyzed results of the propagation characteristics of the reflected wave ray, transmitted wave ray, and diffracted wave ray) are transferred to the electric field intensity calculating unit 312 of FIG. 3.

Subsequently, the ray path tracing apparatus checks whether there is a next intersection point, and, when it is checked that there is the next intersection point, the ray path tracing apparatus returns to operation 710 and performs operations subsequent thereto. When it is checked that there is no next intersection point, the ray path tracing apparatus proceeds to operation 612 of FIG. 6.

Referring again to FIG. 6, the electric field intensity calculating unit 312 calculates electric field intensities at the receiving point about all paths formed between the transmitting point and the receiving point, for example, calculates received powers of all the rays or received power of the diffracted wave ray, on the basis of the analyzed results of the propagation characteristics (i.e., the propagation characteristic of the transmitted wave ray, the propagation characteristic of the reflected wave ray, and the propagation characteristic of the diffracted wave ray) transferred from each of the first and second propagation characteristic analyzing units 308 and 310 in operation 612.

The present invention provides the ray tracing technique using the 3D modeling structure with the consideration of both a thickness of a glass window and a thickness of a window frame, and thus can realize a structure modeling and efficient-processing technology for effectively reducing an error rate of a propagation characteristic prediction result based on ray tracing under the indoor-outdoor communication environment.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A ray path tracing method using a three-dimensional (3D) modeling structure, comprising:
generating and developing a 3D modeling structure of a glass window and a window frame;
setting a ray transmitting point and a ray receiving point at respective positions for predicting in the developed 3D modeling structure, and generating a ray from the transmitting point;
forming a path of a transmitted wave ray, passing through the glass window, between the transmitting point and the receiving point, and analyzing a propagation characteristic of the transmitted wave ray;
forming respective paths of the transmitted wave ray, a reflected wave ray, and a diffracted wave ray, which pass through the window frame, between the transmitting point and the receiving point, and analyzing respective propagation characteristics of the transmitted wave ray, reflected wave ray, and diffracted wave ray; and
calculating electric field intensities at the receiving point about all the paths formed between the transmitting point and the receiving point, on the basis of the analyzed results of the respective propagation characteristics.

2. The ray path tracing method of claim 1, wherein said analyzing respective propagation characteristics comprises:
checking whether a thickness of the window frame is relatively greater than a predetermined reference value compared to a wavelength of the ray;
selecting a first edge at which the ray transferred from the transmitting point intersects the window frame, when the thickness of the window frame is not greater than the predetermined reference value;
analyzing the propagation characteristic of the diffracted wave ray intersecting the first edge;
selecting a plane and a second edge at which the rays transferred from the transmitting point intersect the window frame, when the thickness of the window frame is greater than the predetermined reference value; and
analyzing the propagation characteristics of the reflected wave ray and transmitted wave ray intersecting the plane, and analyzing the propagation characteristic of the diffracted wave ray intersecting the second edge.

3. The ray path tracing method of claim 2, further comprising:
checking, after the analyzing of the propagation characteristics, whether there are a next intersection plane and a next intersection edge; and
repeating the analyzing of the propagation characteristics when there are the next intersection plane and the next intersection edge.

4. The ray path tracing method of claim 1, wherein the electric field intensities are received powers of all the rays or received power of the diffracted wave ray.

5. A ray path tracing apparatus using a three-dimensional (3D) modeling structure, comprising:
a 3D modeling generating unit configured to generate and develop a 3D modeling structure of a glass window and a window frame;
a ray path setting unit configured to set a ray transmitting point and a ray receiving point at respective positions for predicting in the developed 3D modeling structure;
a ray generating unit configured to generate a ray used to analyze a propagation characteristic;
a first propagation characteristic analyzing unit configured to analyze a propagation characteristic of a transmitted wave ray passing through the glass window disposed between the transmitting point and the receiving point;
a second propagation characteristic analyzing unit configured to analyze respective propagation characteristics of the transmitted wave ray, a reflected wave ray, and a diffracted wave ray which pass through the window frame disposed between the transmitting point and the receiving point; and
an electric field intensity calculating unit configured to calculate electric field intensities at the receiving point about all paths formed between the transmitting point and the receiving point, on the basis of the analyzed results from the first and propagation characteristic analyzing units.

6. The ray path tracing apparatus of claim 5, wherein the second propagation characteristic analyzing unit comprises:
a thickness comparator configured to compare a thickness of the window frame and a wavelength of the ray to check whether the thickness of the window frame is relatively greater than a predetermined reference value compared to the wavelength of the ray;
a first point selector configured to select a first edge at which the ray transferred from the transmitting point intersects the window frame, when the thickness of the window frame is not greater than the predetermined reference value;
a 2-1st propagation characteristic analyzer configured to analyze the propagation characteristic of the diffracted wave ray intersecting the first edge;
a second point selector configured to select a plane and a second edge at which the rays transferred from the transmitting point intersect the window frame, when the thickness of the window frame is greater than the predetermined reference value; and
a 2-2nd propagation characteristic analyzer configured to analyze the propagation characteristics of the reflected wave ray and transmitted wave ray intersecting the plane, and analyzing the propagation characteristic of the diffracted wave ray intersecting the second edge.

7. The ray path tracing apparatus of claim 6, further comprising an intersection point monitor configured to analyze the propagation characteristics of the respective rays intersecting the plane and the second edge, check whether there are a next intersection plane and a next intersection edge, and, when there are the next intersection plane and the next intersection edge, command the 2-2nd propagation characteristic analyzer to analyze the propagation characteristics.

8. The ray path tracing apparatus of claim 5, wherein the electric field intensities are received powers of all the rays or received power of the diffracted wave ray.
